(19) United States
(12) Patent Application Publication
(10) Pub. No.: US 2026/0108914 A1
(43) Pub. Date: Apr. 23, 2026

(54) WATERBORNE COATING SYSTEM

(71) Applicant: AXALTA COATING SYSTEMS IP CO., LLC, Wilmington, DE (US)

(72) Inventors: Carmen Flosbach, Wuppertal (DE); Mei Wen, Chesterbrook, PA (US); Lukman Solola, Philadelphia, PA (US); Cen Lin, Claymont, DE (US); Shi Jun Yang, Maple Glen, PA (US); Alpha Zhang, Shanghai (CN); Daniel Pang, Shanghai (CN); Jun Lin, Troy, MI (US); Wiebke Becker, Wuppertal (DE); Eric Houze, Mullica Hill, NJ (US); Klaus Artur Wissing, Haan (DE)

(73) Assignee: AXALTA COATING SYSTEMS IP CO., LLC, Wilmington, DE (US)

(21) Appl. No.: 19/364,096

(22) Filed: Oct. 21, 2025

Related U.S. Application Data
(60) Provisional application No. 63/709,885, filed on Oct. 21, 2024.

(51) Int. Cl. B05D 7/00; B05D 1/02; B05D 7/16

(52) U.S. Cl. CPC B05D 7/574; B05D 1/02; B05D 7/16; B05D 7/576; B05D 2401/20; B05D 2503/00; B05D 2520/05

(57) ABSTRACT

Coating systems, composite articles formed from the coating systems, and methods of forming the composite articles are provided herein. In an embodiment, a coating system comprises a waterborne underlying composition comprising an acrylic latex resin and a two-part waterborne clearcoat composition. The two-part waterborne clearcoat composition comprises a clearcoat binder part and a clearcoat crosslinker part. The clearcoat binder part comprises a water-dilutable, hydroxyl-functional (meth)acrylate copolymer. The clearcoat crosslinker part comprises a polyisocyanate compound having pendant —NCO groups. A cured film of the waterborne clearcoat composition having a film thickness of 67.5 μm overlying a cured film of the waterborne underlying composition having a film thickness of 20 μm disposed on a substrate exhibits a popping density of less than about 3 pops per square centimeter, as measured by visual observation with the naked eye at a distance of 30 cm under a fluorescent light source.

### CROSS REFERENCE TO RELATED APPLICATION

This application claims priority to U.S. Provisional Application No. 63/709,885, filed Oct. 21, 2024, the content of which is incorporated herein by reference.

### TECHNICAL FIELD

The present disclosure generally relates to waterborne coating systems comprising multiple waterborne coating compositions, composite articles formed from the coating compositions, and methods of forming the composite articles. The present disclosure more particularly relates to waterborne coating systems that can be used to form composite articles that exhibit minimized surface defects after curing of all layers.

### BACKGROUND

Coating systems are used in a variety of applications, including in automotive refinishing. A typical coating system includes multiple coating compositions, often selected from a primer composition, a sealer composition, a basecoat composition, a tie composition, and/or a clearcoat composition. When each composition is applied to a substrate or to a previously formed layer, a layer corresponding to each composition is formed. Multiple layers are used because each layer provides unique benefits. A clearcoat or topcoat layer provides benefits such as protection of the underlying layers and substrate from being scratched, chemical damage, or environmental damage. Underlying layers such as a primer, a surfacer, a sealer, or a basecoat layer also provide benefits that are generally known in the field of coating systems. A primer layer provides benefits such as promoting adhesion between the substrate surface and the subsequent coating layers and enhancing the physical properties (e.g. corrosion resistance and/or impact strength) of the overall coating system. A sanding surfacer allows application and sanding to achieve a very smooth layer on which subsequent layers can be applied. A sealer layer provides a barrier that may prevent overlying layers from being absorbed by other underlying layers. A basecoat layer contributes to color or other visual effect of the coating system.

Historically, coating compositions used in coating systems have been solvent-borne, particularly the clearcoat layer, the primer, surfacer, or sealer layer, and thus contained significant amounts of volatile organic compounds (VOC). However, due to environmental considerations, there has been a regulatory drive to reduce the level of such volatile organic compounds in coating systems, especially in applications such as automobile refinish coating systems. One way to reduce VOC content is to use “high solids” coating compositions, in which the amount of organic solvent is reduced relative to the non-volatile components in the coating composition. However, decreasing the amount of organic solvent in a coating composition increases the viscosity of the coating composition, leading to poor flow properties and difficulties in the application and/or the leveling of the composition.

Another way to reduce the VOC content of a coating system is to use waterborne coating compositions. Waterborne coating compositions contain minimal amounts of VOC without compromising the flow properties of the composition (thus avoiding any difficulties with application and/or leveling). However, after a waterborne composition is applied to a substrate to form a layer, water must often be removed for proper crosslinking and curing to occur. Because water has a higher boiling point than many common organic solvents, the water is more difficult to remove through flash drying than many common organic solvents, and water generally must be removed through a baking process under certain conditions for temperature, humidity, and air movement. Some water often remains in the layer after baking (or can be absorbed again into an underlying layer when the next waterborne layer is applied). As described above, it is typically desirable to have multiple coating layers on a substrate. When multiple waterborne layers are formed on top of each other, particularly if any of the underlying layers contain isocyanate, water that is trapped in an underlying layer may react with the isocyanate in its own layer or with any isocyanate that diffuses down from an overlaying layer or evaporates up from a further underlying layer. Also, when the clearcoat contains isocyanate, water trapped in an underlying layer can later diffuse up to the clearcoat layer to react with the isocyanate. Reaction of isocyanate and water forms carbon dioxide. The formed carbon dioxide off-gases during curing of an overlying layer, causing surface defects called “pops” (e.g. pinholes, bubbles, craters, etc.) in the overlying layer. Such surface defects compromise the aesthetic appeal and the protective properties of the coating, particularly when present in a clearcoat layer.

Formation of surface defects is most likely to occur when both the clearcoat layer and the underlying layer(s) are formed from waterborne compositions. Residual water in a clearcoat layer formed from a waterborne clearcoat composition has a higher tendency to diffuse down to the underlying layer(s) if the underlying layer(s) are also formed from waterborne compositions because such underlying layers have a higher affinity to water, particularly when the underlying layers are incompletely dried and typical remediation techniques for treating surface defects, such as sanding, cannot be implemented for the clearcoat. Water trapped inside the coating systems can also make the appearance of the clearcoat worse, leading to formation of textures and fuzziness. The incidence of surface defects also tends to increase with increased film build, or thickness of the layers formed from the waterborne coating compositions. It is often necessary for each layer to be at least a certain thickness in order for the layer to effectively protect the substrate and/or perform its other functions. When the thickness of the waterborne layers is increased in order to improve the effectiveness of the layers, an increased incidence of surface defects may result.

Accordingly, it is desirable to provide a coating system including multiple waterborne coating compositions that can be sequentially applied to a substrate to form overlying layers that are thick enough to be effective for protection of a substrate while exhibiting minimal surface defects (attributable to appreciable amounts of water present in the respective layers) after curing of all layers. Furthermore, other desirable features and characteristics of the present disclosure will become apparent from the subsequent detailed description and the appended claims, taken in conjunction with the accompanying drawings and this background.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Coating systems, composite articles formed from the coating systems, and methods of forming the composite articles are provided herein. In an embodiment, a coating system comprises a waterborne underlying composition and a two-part waterborne clearcoat composition. The waterborne underlying composition comprises an acrylic latex resin. The two-part waterborne clearcoat composition comprises a clearcoat binder part and a clearcoat crosslinker part. The clearcoat binder part comprises a water-dilutable, hydroxyl-functional (meth)acrylate copolymer. The clearcoat crosslinker part comprises a polyisocyanate compound having pendant —NCO groups. The molar ratio of active hydrogen atoms to-NCO groups in the waterborne clearcoat composition is from about 1:5 to about 5:1. A cured film of the waterborne clearcoat composition having a film thickness of 67.5 μm overlying a cured film of the waterborne underlying composition having a film thickness of 20 μm disposed on a substrate exhibits a popping density of less than about 3 pops per square centimeter, as measured by visual observation with the naked eye at a distance of 30 cm under a fluorescent light source.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

Coating systems comprising multiple waterborne coating compositions, composite articles formed from the coating compositions, and methods of forming the composite articles are provided herein. The coating systems include a waterborne underlying composition and a two-part waterborne clearcoat composition, as described in more detail below. In accordance with the present disclosure the coating systems contemplated herein exhibit minimized surface defects after curing of all layers, without compromising other properties of the coating system by reducing the thickness of the layers. More particularly, coating systems are provided herein that, based on chemistries of the waterborne underlying composition and the two-part waterborne clearcoat composition, exhibit a popping density of less than about 3 pops per square centimeter when a cured film of the clearcoat composition has a film thickness of 67.5 μm and a cured film of the waterborne underlying composition has a film thickness of 20 μm. Such performance has yet to be achieved with existing waterborne coating systems.

Unless specifically stated or obvious from context, as used herein, the term “about” is understood as within a range of normal tolerance in the art measured using standard measurement devices for a given measurement, for example within 2 standard deviations of the mean for a particular measurement device. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, “solids content” refers to the percent, by weight, of non-volatile components that would remain after any solvents and/or volatile components are removed from a resin or composition, based on a total weight of the resin or composition.

As used herein, molecular weight of a polymer is measured with gel permeation chromatography (GPC) using polystyrene calibration standards in accordance with ASTM 3536.

As used herein, the “acid value” or “acid number” is a measure of the amount of free acid present in a compound. The acid value is the number of milligrams of potassium hydroxide required for the neutralization of free acid present in one gram of a substance (mg KOH/g). Any measured acid values given herein have been determined in accordance with ASTM D974-22.

As used herein, the “hydroxyl value” or “OH value” is defined as the mass in milligrams of potassium hydroxide required to neutralize the acetic acid taken up on acetylation of one gram of a chemical substance that contains free hydroxyl groups. Where stated, the hydroxyl value is analyzed in accordance with the standard test method ASTM D4274-11.

As used herein, a calculated glass transition temperature (Tg) of a polymer is calculated according to the Fox equation:

$$1 / {T}_{g , polymer} \approx {\sum }_{i} {w}_{i} / {T}_{g , i}$$

where T_{g, polymer} and T_{g,i} are the glass transition temperature of the polymer and of the component monomers (i) respectively, and wᵢ is the mass fraction of component i. The glass transition temperatures of certain homopolymers may be found in the published literature.

As used herein, the minimum film forming temperature (MFFT) refers to the lowest temperature required to coalesce an aqueous polymer dispersion into a thin film when applied to a substrate. The MFFT is determined herein according to ASTM D2354-98 using a Rhopoint Industries BAR-90.

As used herein, “particle size” refers to the largest axis of the particle. In the case of a generally spherical particles, the largest axis is the diameter. The term “mean volume particle size” (Dv50) refers to a particle size corresponding to 50% of the volume of the sampled particles being greater than and 50% of the volume of the samples particles being smaller than the recited Dv50 value. Particle size is determined herein by laser diffraction using Anton Paar Particle Size Analyzer (PSA) Litesizer 500 in accordance with ASTM 5861-07 (2017).

As used herein, “multi-part compositions” are compositions comprising at least two parts which are stored in separate vessels until use because of their reactivity with each other. A “two-part composition” is a multi-part composition having two parts. The parts are mixed before or during application of the composition to form a film. After the parts are mixed, the parts react, typically without requiring additional activation, with bond formation and thereby formation of a polymeric network. Heat may be applied in order to accelerate the reaction of the parts.

As used herein, a “waterborne composition” is a composition in which the solvent or carrier fluid for the composition primarily comprises water. This may mean that water constitutes from about 30% to about 100% by weight, alternatively from about 60% to about 95% by weight, alternatively from about 70% to about 90% by weight, of the liquid solvent in the composition.

As used herein, “water-dilutable polymer” means a polymer that exists in the form of particles in water, the particles being dispersed or suspended and being stable against flocculation upon further dilution with water. In contrast to a water-soluble polymer, a dilute solution (about 1 g/L) of a water-dilutable polymer exhibits scattering when analyzed using dynamic light scattering or any other technique well known in the art of particle analysis.

As used herein, “curing” of a waterborne coating composition refers to the formation of a coating on a substrate through reaction of components in the coating composition. Curing may include crosslinking reactions. Curing may further encompass evaporation of water (and, when present, co-solvent) from the composition (drying) and coalescence of the particulate or dispersed phase of the composition. Curing may be performed under ambient conditions or by deliberate exposure to heat and/or irradiation. The degree of cure may be partial or complete.

As used herein, “ethylenically unsaturated monomer” refers to any monomer containing a terminal double bond capable of polymerization under normal conditions of free-radical polymerization or addition polymerization.

As used herein, “active hydrogen atoms” refers to hydrogen atoms that display activity according to the Zerewitinoff test. Active hydrogen atoms can be derived from hydroxyl, thiol, primary amine, secondary amine, or carboxyl groups.

As used herein, “(meth)acryl” is a shorthand term referring to “acryl” and/or “methacryl.” Thus, the term “(meth)acrylate” refers collectively to acrylate and methacrylate.

As used herein, “film build” refers to the total amount of coating applied to a surface, expressed as a thickness measurement after drying of the coating. “Film thickness” refers to a thickness measurement of a single layer. The film thickness is measured using a Fischer coating thickness gauge DUALSCOPE FMP40.

The coating systems provided herein comprise a waterborne underlying composition and a waterborne clearcoat composition, as described in more detail below. A cured film of the waterborne clearcoat composition having a film thickness of 67.5 μm overlying a cured film of the waterborne underlying composition having a film thickness of 20 μm disposed on a substrate exhibits a popping density of less than about 3 pops per square centimeter, as measured by visual observation with the naked eye at a distance of 30 cm under a fluorescent light source.

The waterborne clearcoat composition is included in the coating system to provide protection for the substrate and the underlying layers, and to impart a desired appearance or visual effect. The waterborne clearcoat composition is a two-part waterborne clearcoat composition that comprises a clearcoat binder part and a clearcoat crosslinker part. The clearcoat binder part is the component containing the water-dilutable, hydroxyl-functional (meth)acrylate copolymer that crosslinks upon curing to form a clearcoat layer. Free hydroxyl groups in the water-dilutable, hydroxyl-functional (meth)acrylate copolymer are capable of reacting, under certain conditions, to form crosslinks. The crosslinks contribute to setting up of the waterborne clearcoat composition to form the clearcoat layer. The clearcoat crosslinker part facilitates the crosslinking of the copolymer and contains a polyisocyanate compound having pendant —NCO groups. The chemistry of the water-dilutable, hydroxyl-functional (meth)acrylate copolymer in the waterborne clearcoat composition leads to rapid emulsification of the polyisocyanate compound, minimizing reaction of residual isocyanate with water, and thus minimizing popping in the clearcoat layer after curing of the waterborne clearcoat composition.

In embodiments, the water-dilutable, hydroxyl functional (meth)acrylate copolymer present in the clearcoat binder part of the two-part waterborne clearcoat composition has a glass transition temperature of from about 20° C. to about 50° C., alternatively from about 30C to about 50° C., alternatively from about 36° C. to about 50° C., as calculated using the Fox equation. A water-dilutable, hydroxyl functional (meth)acrylate copolymer having a glass transition temperature in the recited range may contribute to effective drying of the waterborne clearcoat composition and/or durability of a cured film of the clearcoat composition. In embodiments, the water-dilutable, hydroxyl functional (meth)acrylate copolymer has a hydroxyl value of from about 110 mgKOH/g to about 160 mgKOH/g, alternatively from about 110 mgKOH/g to about 140 mgKOH/g, as analyzed in accordance with the standard test method ASTM D4274-11. The hydroxyl value affects the degree of crosslinking during curing of the waterborne clearcoat composition. In embodiments, the water-dilutable, hydroxyl functional (meth)acrylate copolymer has an acid value of from about 20 mgKOH/g to about 40 mgKOH/g, alternatively from about 20 mgKOH/g to about 28 mgKOH/g, determined in accordance with ASTM D974-22. In embodiments, the water-dilutable, hydroxyl functional (meth)acrylate copolymer has a weight average molecular weight of from about 10,000 Daltons to about 30,000 Daltons, alternatively from about 10,000 Daltons to about 20,000 Daltons, as measured by gel permeation chromatography (GPC) using polystyrene calibration standards in accordance with ASTM 3536.

The water-dilutable, hydroxyl-functional (meth)acrylate copolymer is the reaction product of monomers in a monomer mixture. The types of monomers present in the monomer mixture may affect the appearance, popping performance, and durability of a cured film of the waterborne clearcoat composition. The polymerization of the component monomers will conventionally be a free-radical solution polymerization. A two-step, free radical solution polymerization (e.g. a skew feed polymerization) may be used.

In embodiments, the monomer mixture contains (i) a hydroxyl functional adduct of a monoepoxyester and an unsaturated carboxylic acid. Typically the adduct is formed via a nucleophilic addition reaction of the monoepoxyester with the acid to form a hydroxyalkyl ester. This acidolysis ring-opening reaction conventionally requires a catalyst. The catalyst may be selected from tertiary amines, quaternary ammonium compounds, and/or transition metals compounds. The reactant monoepoxyesters are typically glycidyl esters derived from aliphatic saturated monocarboxylic acids having a tertiary or quaternary carbon atom in the alpha position. In embodiments, the reactant monoepoxyesters are glycidyl esters of saturated α,α-dialkylalkane-monocarboxylic acids having from 5 to 13 carbon atoms or from 9 to 11 carbon atoms in the acid molecule. The reactant acid functional compound can be aliphatic unsaturated monocarboxylic acids such as α,β-monoethylenically unsaturated monocarboxylic acids, C₁-C₆ alkyl half-esters of α,β-monoethylenically unsaturated dicarboxylic acids, or C₁-C₆ alkyl esters of α,β-monoethylenically unsaturated tricarboxylic acids bearing one free carboxylic acid group. In embodiments, the reactant acid functional component is (meth)acrylic acid. In embodiments, the monomer (i) is present in the monomer mixture in an amount of from about 10% wt % to about 80 wt %, alternatively from about 20 wt % to about 60 wt %, alternatively from about 30 wt % to about 60 wt %, based on a total weight of monomers in the mixture.

In embodiments, the monomer mixture contains (ii) a hydroxyl functional unsaturated monomer different from monomer (i). The monomer (ii) may be selected from hydroxyalkyl esters with primary or secondary hydroxyl groups derived from α,β-monoethylenically unsaturated monocarboxylic acids. For example, the monomer may be selected from hydroxyalkyl esters derived from acrylic acid, methacrylic acid, crotonic acid, or isocrotonic acid. In embodiments, monomer component (ii) comprises a hydroxyl (meth)acrylate monomer represented by Formula HMA:

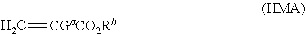

Where G^{a} is hydrogen, halogen, or methyl; and R^{h} is C₁-C₁₈ hydroxyalkyl. In embodiments, the monomer component (ii) may be selected from hydroxyethyl (meth)acrylate, 1-hydroxypropyl (meth)acrylate, 2-hydroxypropyl (meth)acrylate, 1-hydroxybutyl (meth)acrylate, 2-hydroxybutyl (meth)acrylate, and 3-hydroxybutyl (meth)acrylate. In embodiments, the monomer (ii) is present in the monomer mixture in an amount of from about 0 wt % to about 40 wt %, alternatively from about 10 wt % to about 30 wt %, alternatively from about 10 wt % to about 25 wt %, alternatively from about 10 wt % to about 20 wt %, based on a total weight of monomers in the mixture.

In embodiments, the monomer mixture contains (iii) an unsaturated acid functional monomer different from monomers (i) and (ii). Regarding (iii) the unsaturated acid functional monomer, in embodiments, the monomer is chosen from ethylenically unsaturated carboxylic acids, ethylenically unsaturated sulfonic acids, vinylphosphonic acid, and mixtures thereof. Suitable ethylenically unsaturated sulfonic acids include, for example, vinylsulfonic acid, styrenesulfonic acid, or acrylamidomethylpropanesulfonic acid. In embodiments, monomer component (iii) comprises an ethylenically unsaturated carboxylic acid chosen from α,β-monoethylenically unsaturated monocarboxylic acids, α,β-monoethylenically unsaturated dicarboxylic acids, C1-C6 alkyl half-esters of α,β-monoethylenically unsaturated dicarboxylic acids, α,β-monoethylenically unsaturated tricarboxylic acids, C₁-C⁶ alkyl esters of α,β-monoethylenically unsaturated tricarboxylic acids bearing at least one free carboxylic acid group, or mixtures thereof. In embodiments, the monomer component (iii) comprises an ethylenically unsaturated carboxylic acid chosen from methacrylic acid, acrylic acid, itaconic acid, maleic acid, aconitic acid, crotonic acid, fumaric acid, or mixtures thereof. In embodiments, the monomer (iii) is present in the monomer mixture in an amount of from about 1 wt % to about 8 wt %, alternatively from about 2 wt % to about 6 wt %, alternatively from about 2 wt % to about 5 wt %, alternatively from about 2 wt % to about 4 wt %, based on a total weight of monomers in the mixture.

In embodiments, the monomer mixture contains (iv) a (meth)acrylate monomer represented by Formula MA:

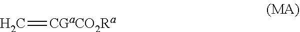

In the Formula MA, G^{a} is hydrogen, halogen, or methyl. R^{a} is C1-C18 alkyl, C2-C18 heteroalkyl, C3-C18 cycloalkyl, C2-C8 heterocycloalkyl, C2-C8 alkenyl, or C2-C8 alkynyl. In embodiments, R^{a} is C1-C18 alkyl or C3-C18 cycloalkyl. Examples of (meth)acrylate monomers in accordance with Formula MA include methyl (meth)acrylate, ethyl (meth)acrylate, n-butyl (meth)acrylate, isobutyl (meth)acrylate, hexyl (meth)acrylate, 2-ethylhexyl (meth)acrylate, isodecyl (meth)acrylate, dodecyl (meth)acrylate, lauryl (meth)acrylate, stearyl (meth)acrylate, cyclohexyl (meth)acrylate, 3,3,5-trimethylcyclohexyl (meth)acrylate, 4-tert-butyl cyclohexyl (meth)acrylate, isobornyl (meth)acrylate, norbornyl (meth)acrylate, dihydrodicyclopentandienyl (meth)acrylate, ethylene glycol monomethyl ether (meth)acrylate, ethylene glycol monoethyl ether (meth)acrylate, ethylene glycol monododecyl ether (meth)acrylate, diethylene glycol monomethyl ether (meth)acrylate, trifluoroethyl (meth)acrylate, and perfluorooctyl (meth)acrylate. In embodiments, monomer component (iv) comprises a (meth)acrylate monomer which, if homopolymerized, would yield a homopolymer having a glass transition temperature (Tg) of greater than about 30° C. In embodiments, the monomer (iv) is present in the monomer mixture in an amount of from about 20 wt % to about 60 wt %, alternatively from about 25 wt % to about 50 wt %, based on a total weight of monomers in the mixture.

In embodiments, the monomer mixture contains (v) at least one vinyl aromatic monomer different from monomers (i)-(iv). In embodiments, the monomer component (v) comprises a vinyl aromatic monomer of Formula (VA)

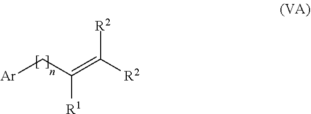

where R¹ is H or C1-C4 alkyl; each R² is independently hydrogen or C1-C4 alkyl; Ar is unsubstituted phenyl or phenyl substituted with from 1 to 5 substituents, wherein each substituent is independently halogen or C1-C4 alkyl; and n is an integer from 0 to 4. In embodiments, R¹ is H or methyl; each R² is independently H or methyl; Ar is unsubstituted phenyl or phenyl substituted with from 1 to 5 substituents, wherein each substituent is independently halogen or C1-C4 alkyl; and n is 0 or 1. In embodiments, the monomer component (v) is selected from styrene, α-methylstyrene, 2-methylstyrene, 3-methylstyrene, 4-methylstyrene, 2-tert-butyl styrene, 4-tert-butylstyrene, 2-chlorostyrene, 4-chlorostyrene, or combinations thereof. In embodiments, the monomer (v) is present in the monomer mixture in an amount of from about 0 wt % to about 20 wt %, alternatively from about 0 wt % to about 15 wt %, alternatively from about 4 wt % to about 14 wt %, based on a total weight of the monomer mixture.

In embodiments, the monomer mixture contains (vi) at least one polymerizable unsaturated monomer that is different from (i) to (v). Regarding (vi) the at least one polymerizable unsaturated monomer that is different from (i) to (v), in embodiments, the monomer component (vi) is selected from aromatic (meth)acrylate monomers, (meth)acrylate functionalized oligomers, nitrogen (N—) functionalized ethylenically unsaturated monomer, silane-functional ethylenically unsaturated monomers such as methacryloxypropyl tri(C1-C5)alkoxysilanes and vinyl tri(C1-C5)alkoxysilanes, acetoacetyl-functional unsaturated monomers such as acetoacetoxy ethylmethacrylate, vinyl esters, vinyl and vinylidene halides, vinyl ethers, alkyl vinyl ketones, cycloalkyl vinyl ketones, heterocyclic aliphatic vinyl compounds, poly(meth)acrylates of alkane polyols, poly(meth)acrylates of oxyalkane polyols, poly(C2-C3)alkylene glycol di(meth)acrylates, or combinations thereof. Suitable aromatic (meth)acrylate monomers include those represented by Formula AII:

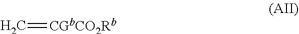

wherein G^{b} is hydrogen, halogen or methyl; and Rb is C6-C18 aryl, C1-C9 heteroaryl, C7-C18 alkoxyaryl, C7-C18 alkaryl or C7-C18 aralkyl. In embodiments, the monomer (vi) is present in the monomer mixture in an amount of from about 0 wt % to about 70 wt %, alternatively from about 1 wt % to about 20 wt %.

In embodiments, the water-dilutable, hydroxyl-functional (meth)acrylate copolymer is present in the clearcoat binder part in an amount of from about 20 wt % to about 60 wt %, alternatively from about 35 wt % to about 55 wt %, based on a total weight of the clearcoat binder part.

In embodiments, the clearcoat binder part further comprises a non-aromatic polyester having active hydrogen groups. The presence of the polyester in the clearcoat binder part may improve the appearance, durability, and/or chemical stability of a cured film of the waterborne clearcoat composition. In embodiments, the non-aromatic polyester has a number average molecular weight (Mn) of from about 500 to about 5000 Daltons, alternatively from about 500 to about 1500 Daltons; an acid value from about 0 to about 30 mg KOH/g; a hydroxyl value of from about 100 to about 600 mg KOH/g, alternatively from about 250 to about 400 mg KOH/g; and a calculated hydroxyl functionality of from about 2 to about 8, alternatively from about 4 to about 8.

In embodiments, the non-aromatic polyester is prepared by a polycondensation of a hydroxyl functional component, a carboxyl functional component, and optionally a hydroxycarboxylic acid component. The polycondensation reaction may be exemplified by a stoichiometric excess of hydroxyl groups to carboxyl groups. For example, the stoichiometric excess of hydroxyl groups to carboxyl groups may be from about 5 mol % to about 40 mol %, alternatively from about 5 mol % to about 35 mol %, alternatively from about 5 mol % to about 30 mol %, alternatively from about 5 mol % to about 25 mol %. In embodiments, the hydroxyl functional component comprises, based on a total weight of the hydroxyl functional component, from about 75 wt % to about 100 wt %, alternatively from about 80 wt % to about 100 wt %, alternatively from about 90 wt % to about 100 wt %, alternatively from about 95 wt % to about 100 wt %, of a polyol having from 3 to 6 hydroxyl groups; and from about 0 wt % to about 25 wt %, alternatively from about 0 wt % to about 20 wt %, alternatively from about 0 to about 10 wt %, alternatively from about 0 wt % to about 5 wt %, of a diol. In embodiments, the carboxyl functional component comprises, based on a total weight of the carboxyl functional component, from about 75 wt % to about 100 wt %, alternatively from about 80 wt % to about 100 wt %, alternatively from about 90 wt % to about 100 wt %, of a dicarboxylic acid; and from about 0 wt % to about 25 wt %, alternatively from about 0 wt % to about 20 wt %, alternatively from about 0 wt % to about 10 wt %, of a monocarboxylic acid.

In embodiments, the non-aromatic polyester is present in the clearcoat binder part in an amount of from about 0 wt % to about 20 wt %, alternatively from about 0 wt % to about 10 wt %, alternatively from about 0 wt % to about 5 wt %, based on a total weight of the clearcoat binder part. In embodiments, the weight ratio of the hydroxyl-functional (meth)acrylate copolymer to the non-aromatic polyester is from about 100:1 to about 100:35, alternatively from about 100:5 to about 100:25, alternatively from about 100:5 to about 100:20, alternatively from about 100:5 to about 100:15.

In embodiments, the clearcoat binder part further comprises a non-polymeric polyol. As used herein, a “polyol” refers to any compound having two or more hydroxyl groups. The term “polyol” is thus intended to encompass diols, triols, and compounds containing four or more hydroxyl groups. Inclusion of the non-polymeric polyol may contribute to the humidity resistance of the waterborne clearcoat composition and may also contribute to effective mixing of the clearcoat binder part and the clearcoat crosslinker part when they are combined. In embodiments, the non-polymeric polyol has a weight average molecular weight of less than about 300 Daltons and a water solubility at 20° C. of less than about 6 g/100 ml of water. In embodiments, the non-polymeric polyol is selected from 2-ethylhexane-1,3-diol; 2-butyl-2-ethyl-1,3-propanediol, or combinations thereof. The non-polymeric polyol may be present in the clearcoat binder part in an amount of from about 0 wt % to about 5 wt %, alternatively from about 0 wt % to about 5 wt %, alternatively from about 0 wt % to about 2 wt %, alternatively from about 0 wt % to about 1.5 wt %, based on a total weight of the clearcoat binder part.

The clearcoat crosslinker part comprises a polyisocyanate compound having pendant —NCO groups. The clearcoat crosslinker part may comprise only one polyisocyanate compound, or alternatively, the clearcoat crosslinker part may comprise more than one polyisocyanate compound. Suitable polyisocyanates include aliphatic, cycloaliphatic, aromatic and heterocyclic isocyanates, dimers and trimers thereof, and combinations thereof.

In embodiments, the molar ratio of active hydrogen atoms to-NCO groups in the waterborne clearcoat composition is from about 1:5 to about 5:1, alternatively from about 1:3 to about 3:1, alternatively from about 1:2 to about 2:1, alternatively from about 1:1.5 to about 1.5:1.

The waterborne underlying composition is any waterborne coating composition that can be applied to a substrate or to a coating layer disposed on a substrate prior to application of the waterborne clearcoat composition. There may be only one waterborne underlying composition, or alternatively, there may be more than one waterborne underlying composition in the coating system provided herein. The waterborne underlying composition is provided for a variety of reasons, depending on the type of application and intended role of the composition. After applying and curing in a coating system, a layer formed from the waterborne underlying composition may provide protection to a substrate, form a smooth layer on which other layers can be deposited, prevent absorption of the substrate by overlying layers, enhance adhesion of layers in the coating system, or provide a desired visual effect. The waterborne underlying composition may be, for example, a surfacer composition, a sealer composition, a primer composition, a basecoat composition, or a tie layer composition.

The waterborne underlying composition comprises an acrylic latex resin. Use of the acrylic latex resin in the waterborne underlying composition leads to faster release of water upon curing of an underlying layer formed from the waterborne underlying composition and prevents reentry of water into the underlaying layer from subsequently applied waterborne compositions. In embodiments, the waterborne underlying composition is a waterborne surfacer composition. After application of the waterborne surfacer composition, curing of the resulting layer, and sanding of the resulting layer, a smooth layer is provided on which other layers can be applied evenly. The waterborne surfacer composition comprises a surfacer binder part. In embodiments, the waterborne surfacer composition is a two-part composition that further comprises a surfacer crosslinker part. The surfacer binder part is the component containing the polymer that “sets up” upon curing, for example to form a substantially crosslinked polymer film. The surfacer binder part comprises a core-shell latex comprising a core copolymer and a shell copolymer. The core copolymer and the shell copolymer have pendant carbonyl groups. The carbonyl groups in the copolymer are capable of reacting, under certain conditions, to form crosslinks. The crosslinks may contribute to setting up of the waterborne surfacer composition to form a surfacer coating layer. The surfacer crosslinker part may facilitate the crosslinking of the core-shell latex copolymer.

As used herein, the term “core-shell latex copolymer” references a latex copolymer that is made in a staged polymerization process having at least two polymerization stages. In one of the stages, an emulsion polymerization process is conducted to produce the “core” copolymer. In another of the stages, an emulsion polymerization process is conducted to form the “shell” copolymer. In an embodiment, the core copolymer is synthesized in a free-radical emulsion polymerization stage which precedes the stage of the synthesis of the shell copolymer by free-radical emulsion polymerization: the shell copolymer will typically be formed in the presence of particles of the core copolymer in these embodiments. In another embodiment, typically where the core copolymer is more hydrophobic than the shell copolymer, the stage of free-radical emulsion polymerization of the shell copolymer may precede the stage of the free-radical emulsion polymerization of the core copolymer. In embodiments, additional polymerization stages to the core- and shell-forming stages may be conducted. Exemplary additional polymerization stages may occur before that stage forming the core polymer, between the stage of core polymerization and the stage of shell polymerization, or after the stage of shell polymerization.

In embodiments, the core copolymer accounts for at least about 10 wt %, alternatively from about 10 wt % to about 70 wt %, alternatively from about 10 wt % to about 60 wt %, of the total weight of monomer components in the core-shell latex copolymer. In embodiments, the calculated Tg of the core copolymer is at least about 20° C. greater, alternatively at least about 30° C. greater, than the calculated Tg of the shell copolymer. In embodiments, the core polymer has a higher glass transition temperature (Tg) than the shell polymer. In embodiments, the core polymer has a calculated Tg of from about 20° C. to about 80° C., alternatively from about −30° C. to about 80° C., alternatively from about 40° C. to about 80° C. In embodiments, the shell copolymer has a calculated Tg of from about −30° C. to about 30° C., alternatively from about −30° C. to about 15° C., alternatively from about −25° C. to about 10° C. In embodiments, the core-shell latex copolymer has a calculated Tg of from about −20° C. to about 40° C. In embodiments, the core-shell latex copolymer has a minimum film forming temperature of less than about 45° C., alternatively less than about 40° C., alternatively less than about 35° C., alternatively less than about 30° C. without any coalescent or solvent presence. In embodiments, the core-shell latex copolymer has a mean volume particle size (dv50) of from about 10 nm to about 1000 nm, alternatively from about 50 nm to about 500 nm, alternatively from about 50 nm to about 400 nm, as measured using laser diffraction in accordance with ASTM 5861-07 (2017).

In embodiments, the pendant carbonyl groups of the core polymer and the shell polymer are selected from keto groups, aldehyde groups, or combinations thereof. As used herein, the term “keto group”” refers to a group in which a carbonyl group is bonded to two carbon atoms. The keto group may be represented by the formula R₂C═O wherein neither R may be H. In embodiments, the core polymer and/or the shell polymer also have isocyanate-reactive groups. In embodiments, the isocyanate-reactive groups are chosen from hydroxyl groups, amine groups, or combinations thereof. In embodiments, each of the core copolymer and the shell copolymer is formed from a (meth)acrylate monomer represented by Formula MA, as described above. In embodiments, each of the core polymer and the shell copolymer is formed from a vinyl aromatic monomer, optionally a monomer having at least two (meth)acrylate groups, a monomer having an allyl group and a (meth)acrylate group, and/or a hydroxyl functional ethylenically unsaturated monomer. In embodiments, the core copolymer and/or the shell copolymer is formed from a carbonyl functional ethylenically unsaturated monomer.

Regarding the (meth)acrylate monomers represented by the Formula MA, in embodiments, the monomer is represented by the Formula MA1:

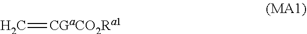

wherein G^{a} is hydrogen, halogen or methyl; and R^{a1} is C1-C18 alkyl, C2-C18 heteroalkyl, C3-C18 cycloalkyl, C2-C8 heterocycloalkyl, C2-C8 alkenyl or C2-C8 alkynyl. In embodiments, the monomer is represented by the Formula MA2:

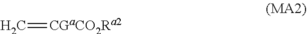

wherein G^{a} is hydrogen, halogen or methyl; and R^{a2} is C6-C18 aryl, C1-C9 heteroaryl, C7-C18 alkoxyaryl, C7-C18 alkaryl or C7-C18 aralkyl.

Regarding the vinyl aromatic monomers, in embodiments, the vinyl aromatic monomers are represented by the Formula (VA), as defined above. In embodiments, the vinyl aromatic monomers are chosen from styrene, α-methylstyrene, 2-methylstyrene, 3-methylstyrene, 4-methylstyrene, 2-tert-butyl styrene, 4-tert-butylstyrene, 2-chlorostyrene, 4-chlorostyrene, or combinations thereof.

In embodiments, the monomer having at least two (meth)acrylate groups is represented by the Formula DA1:

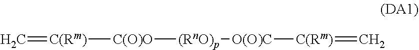

wherein each R^{m} is independently H or CH₃, each Rⁿ is independently C2-C4 alkylene, and p is an integer of from 1 to 8. In embodiments, the monomer is selected from tetraethylene glycol di(meth)acrylate, triethylene glycol di(meth)acrylate, tripropylene glycol di(meth)acrylate, dipropylene glycol di(meth)acrylate, or combinations thereof.

Suitable hydroxyl functional ethylenically unsaturated monomers which may be utilized in the synthesis of core-shell latex copolymer include hydroxyalkyl esters with primary or secondary hydroxyl groups derived from α,β-monoethylenically unsaturated monocarboxylic acids. These can include, for instance, hydroxyalkyl esters derived from acrylic acid, methacrylic acid, crotonic acid or iso-crotonic acid. The hydroxyl functional ethylenically unsaturated monomer may be present in an amount of from about 70 wt % to about 100 wt %, alternatively from about 80 wt % to about 100 wt %, alternatively from about 90 wt % to about 100 wt %, based on a total weight of hydroxyl functional unsaturated monomers in the core-shell latex copolymer.

In embodiments, the core-shell latex copolymer is present in the surfacer binder part in an amount of from about 5 wt % to about 100% wt %, alternatively from about 10 wt % to about 90 wt %, alternatively from about 15 wt % to about 80 wt %, alternatively from about 30 wt % to about 75 wt %, based on a total weight of the surfacer binder part.

In embodiments, the surfacer binder part further comprises an additional copolymer that is different than the core-shell latex polymer. The presence of the additional copolymer in the surfacer binder part may affect the crosslinking density of a cured film of the waterborne surfacer composition. The additional copolymer may also contribute to the stability of a cured film of the waterborne surfacer composition and/or the adhesion of a cured film of the waterborne surfacer composition to a substrate or to other coating layers. The additional copolymer may comprise functional groups that can participate in crosslinking reactions. In embodiments, the additional copolymer is reactive with hydrazide groups. In embodiments, the additional copolymer is a water-dilutable, hydroxyl functional (meth)acrylate copolymer. In embodiments, the water-dilutable, hydroxyl functional (meth)acrylate copolymer has the characteristics described above in relation to the water-dilutable, hydroxyl functional (meth)acrylate copolymer present in the clearcoat binder part. In embodiments, the water-dilutable, hydroxyl functional (meth)acrylate copolymer is present in the surfacer binder part in an amount of from about 5 wt % to about 70 wt %, alternatively from about 10 wt % to about 50 wt %, based on a total weight of the surfacer binder part.

In embodiments, the surfacer binder part further comprises a polyhydrazide compound. Alternatively, the hydrazide compound can be provided separately as an additional surfacer part separate from the surfacer binder part and the surfacer crosslinker part. The polyhydrazide compound is reactive with the pendant carbonyl groups in the core polymer and the shell copolymer. The polyhydrazide may also be reactive with the additional copolymer that is different from the core-shell latex copolymer. The polyhydrazide compound is especially suitable for reacting with keto groups. Inclusion of the polyhydrazide compound in the surfacer binder part may lead to a dual crosslinking reaction when the surfacer binder part and the surfacer crosslinker part are combined (polyhydrazide/carbonyl crosslinking reaction and isocyanate/isocyanate-reactive group crosslinking reaction). The dual crosslinking reaction accelerates the film formation process and contributes to the hardness of the resulting coating layer after curing. Further, when the polyhydrazide compound is included in the waterborne surfacer composition, the crosslinking reaction can occur with the addition of less polyisocyanate than would be required in the absence of the polyhydrazide compound. Minimizing the amount of isocyanate present in the composition reduces the risk of popping in the coating system after curing of all layers.

In embodiments, the polyhydrazide compound has at least two hydrazide groups of the formula —C(═O)—NH—N(R^{h})(Rⁱ), wherein R^{h} and Rⁱ are independently H or C1-C12 alkyl. In embodiments, such hydrazide groups are part of larger groups, such as those of the formula -L-C(═O)NH—N(R^{h})(Rⁱ), wherein L is a divalent linking group chosen from —O—, —NH—, C1-C18 alkylene, C2-C18 alkenylene, C3-C18 cycloalkylene or C6-C18 arylene. In embodiments, the polyhydrazide has from 2 to 5 hydrazide functional groups, alternatively from 2 to 4 hydrazide functional groups. The polyhydrazide may be polymeric, nonpolymeric, or a combination thereof. Examples of nonpolymeric polyhydrazides include hydrazide derivatives of aliphatic, cycloaliphatic or aromatic polycarboxylic acids. In embodiments, the polyhydrazide is a dihydrazide having the formula H₂N—N(H)—C(O)-L¹-C(O)—N(H)—NH₂, wherein L¹ is a divalent linking group chosen from a covalent bond, C₁-C₁₈ alkylene, C₂-C₁₈ alkenylene, C₃-C₁₈ cycloalkylene or C₆-C₁₈ arylene.

In embodiments, the polyhydrazide compound is present in the surfacer binder part in an amount of from about 0.1 wt % to about 30 wt %, alternatively from about 0.5 wt % to about 15 wt %, alternatively from about 1 wt % to about 10 wt %, based on a total weight of the waterborne surfacer composition. In embodiments, the molar ratio of hydrazide groups to carbonyl groups in the waterborne surfacer composition is from about 1:5 to about 5:1, alternatively from about 1:3 to about 3:1, alternatively from about 1:2 to about 2:1.

In embodiments, the surfacer binder part further comprises a surfactant. The surfactant may be selected from anionic surfactants, nonionic surfactants, amphoteric surfactants, cationic surfactants, reactive surfactants, or combinations thereof. In embodiments, the surfacer binder part further comprises an additional additive chosen from polymeric stabilizer, an emulsifier, a buffering agent, an inorganic electrolyte, a biocide, an antifoam agent, and/or a pH adjusting agent.

The surfacer crosslinker part comprises a polyisocyanate compound as described above in relation to the clearcoat crosslinker part. The surfacer crosslinker part may contain only one polyisocyanate compound, or alternatively, the surfacer crosslinker part may contain more than one polyisocyanate compound. The polyisocyanate compound may be present in the surfacer crosslinker part in an amount of from about 30 wt % to about 90 wt %, alternatively from about 40 wt % to about 80 wt %, based on a total weight of the surfacer crosslinker part. The surfacer crosslinker part may further comprise additional crosslinker(s) different from the polyisocyanate compound(s).

In embodiments, the waterborne underlying composition is a waterborne sealer composition. After application of the waterborne sealer composition and curing of the resulting sealer layer, the sealer layer may protect the substrate and inhibit diffusion of chemicals into or out of the substrate and/or the overlying coating layers. The sealer layer may also provide a layer possessing consistent surface energy across its upper surface. In embodiments, the waterborne sealer composition comprises an acrylic latex resin having a core-crosslinked structure that is free of a core-shell latex and a polyurethane comprising a hydroxyl functional reaction product of a polyisocyanate and a polyol comprising a polycarbonate diol. As used herein, a “core-crosslinked structure” means that the acrylic latex resin is characterized by a crosslinked structure resulting from the use of olefinically polyunsaturated monomers in all the stages of an emulsion polymerization. Thus, the structure of the acrylic latex resin is fully crosslinked as a result of the formation process before any composition that includes the acrylic latex resin is cured.

In embodiments, the waterborne underlying composition is a waterborne basecoat composition. In embodiments, the waterborne basecoat composition comprises a color and/or visual effect imparting compound. Waterborne basecoat compositions are known in the art and may be used to form a basecoat layer.

The composite articles provided herein are formed from the coating systems provided herein. The composite article comprises a substrate, an underlying layer disposed over the substrate, and a clearcoat layer disposed over the underlying layer. The substrate is provided as the surface or object that requires protection by a coating. The substrate may be chosen from a variety of materials such as metal, plastic, glass, or wood. The substrate may be an object or surface such as a structural wall, a kitchen appliance, or an automotive part. In embodiments, the substrate may be coated with an electrocoating. For purposes of this description, the “substrate” includes any electrocoating or other pretreatment that is present on the substrate prior to formation of the underlying layer on the substrate.

There may be only one underlying layer, or alternatively, there may be more than one underlying layer. The underlying layer disposed over the substrate may cover the entire surface of the substrate, or alternatively, the underlying layer may cover only a portion of the surface of the substrate. The underlying layer may cover only one surface of the substrate, or alternatively, the underlying layer may cover multiple surfaces of the substrate. The underlying layer is formed from a waterborne underlying composition comprising an acrylic latex resin, as described above. The film thickness of the layers impacts performance parameters. A greater film thickness generally provides more protection for the substrate, but a greater film thickness may also lead to a higher amount of popping or surface defects resulting from reaction of isocyanate and water to form carbon dioxide that off-gases. In embodiments, the underlying layer is a surfacer layer having a film thickness of from about 30 μm to about 200 μm, alternatively from about 35 μm to about 130 μm. In embodiments, the underlying layer is a sealer layer having a film thickness of from about 10 μm to about 30 μm, alternatively from about 15 μm to about 25 μm. In embodiments, the underlying layer is a primer layer having a film thickness of from about 30 μm to about 180 μm, alternatively from about 40 μm to about 150 μm.

The clearcoat layer is disposed over the underlying layer. The clearcoat layer may cover the entire surface of the underlying layer, or alternatively, the clearcoat layer may cover only a portion of the surface of the underlying layer. The clearcoat layer is formed from a two-part waterborne clearcoat composition, as described above. In embodiments, the clearcoat layer has a film thickness of from about 30 μm to about 100 μm, alternatively from about 30 μm to about 90 μm, alternatively from about 40 μm to about 90 μm.

In embodiments, the composite article comprises a surfacer layer disposed over the substrate, a sealer layer disposed over the surfacer layer, a basecoat layer disposed over the sealer layer, and a clearcoat layer disposed over the basecoat layer. The composite article may further comprise a tie layer disposed over the basecoat layer and under the clearcoat layer. In embodiments, a primer layer is also present. The primer layer may be disposed over the substrate and under the surfacer layer. In embodiments, either the surfacer layer or the sealer layer may not be present. In embodiments, the composite article is free of any layers formed from a solvent borne coating composition.

The coating systems and composite articles provided herein are characterized by the performance parameters of cured layers formed from the waterborne coating compositions over a substrate. Specifically, a cured film of the waterborne clearcoat composition having a film thickness of 67.5 μm overlying a cured film of the waterborne underlying composition having a film thickness of 20 μm disposed on a substrate exhibits a popping density of less than about 3 pops per square centimeter, alternatively less than about 2.5 pops per square centimeter, alternatively less than about 2.2 pops per square centimeter, alternatively from about 0 to about 2.2 pops per square centimeter, as measured by visual observation with the naked eye at a distance of 30 cm under a fluorescent light source. The recited performance may be achievable under various conditions. For example, the recited performance may be achieved when the films are flash dried for 5-15 minutes and then cured for 30 minutes in an oven preheated to a baking temperature of about 60° C. with an air flow of from about 35 meters per minute to about 55 meters per minute. The recited performance may also be achieved when the films are flash dried for 5-15 minutes and then cured for 30 minutes in an oven that is not preheated but is set to a baking temperature of about 60° C. and allowed to heat up over a period of about 7 minutes to about 10 minutes, and when the air flow is from about 10 meters per minute to about 25 meters per minute. The recited performance may also be achieved when the films are cured by air drying, for example overnight.

In embodiments, a cured film of the waterborne clearcoat composition having a film thickness of 67.5 μm overlying a cured film of the waterborne underlying composition having a film thickness of 20 μm disposed on a substrate exhibits a popping density of less than about 0.1 pops per square centimeter, alternatively from about 0 to about 0.1 pops per square centimeter. The recited performance may be achievable under various conditions, as described above. In particular, the recited performance may be achieved when the films are flash dried for 5-15 minutes and then cured for 30 minutes in an oven that is not preheated but is set to a baking temperature of about 60° C. and allowed to heat up over a period of about 7 minutes to about 10 minutes, and when the air flow is from about 10 meters per minute to about 25 meters per minute.

In embodiments, a cured film of the waterborne clearcoat composition having a film thickness of 67.5 μm overlying a cured film of the waterborne underlying composition having a film thickness of 120 μm disposed on a substrate exhibits a popping density of less than about 3 pops per square centimeter, alternatively less than about 2.5 pops per square centimeter, alternatively less than about 2.2 pops per square centimeter, alternatively from about 0 to about 2.2 pops per square centimeter, as measured by visual observation with the naked eye at a distance of 30 cm under a fluorescent light source. In particular, the recited performance may be achieved in embodiments wherein the waterborne underlying composition is a waterborne surfacer composition. The recited performance may be achieved under various conditions, as described above.

In embodiments, under commercial spray booth conditions, a cured film of the waterborne clearcoat composition having a film thickness of 67.5 μm overlying a cured film of the waterborne underlying composition having a film thickness of 120 μm disposed on a substrate exhibits a popping density of less than about 0.1 pops per square centimeter, alternatively from about 0 to about 0.1 pops per square centimeter. In particular, the recited performance may be achieved in embodiments wherein the waterborne underlying composition is a waterborne surfacer composition. The recited performance may be achievable under various conditions, as described above. In particular, the recited performance may be achieved when the films are flash dried for 5-15 minutes and then cured for 30 minutes in an oven that is not preheated but is set to a baking temperature of about 60° C. and allowed to heat up over a period of about 7 minutes to about 10 minutes, and when the air flow is from about 10 meters per minute to about 25 meters per minute.

As used herein, “popping density” refers to the number of pops present in the clearcoat layer per square centimeter area of the surface of the clearcoat layer. A “pop” means a surface defect resulting from formation of carbon dioxide inside a layer and subsequent blowing out of the carbon dioxide. The resulting pop may be in the form of a bubble, a crater or dimple, or another surface defect. For purposes of this disclosure, the popping density is measured by visually observing a surface area of 1 cm by 8 cm on the surface of the clearcoat layer with the naked eye at a distance of 30 cm under a fluorescent light source. The number of pops in the area is counted, and the number of pops is divided by the area of observation (popping density=number of pops/8 cm²). In embodiments, three separate areas of the coating layer are observed to determine the popping density of each area, and the average popping density over the three areas is reported (average popping density=(popping density of area 1+popping density of area 2+popping density of area 3)/3).

The recited popping density of less than about 3 pops per square centimeter may not be achievable with existing waterborne coating systems when a cured film of the waterborne clearcoat composition has a film thickness of 67.5 μm and an underlying cured film of a waterborne underlying composition has a film thickness of 20 μm. As explained above, multilayer waterborne coating systems tend to exhibit an unacceptable amount of popping resulting from the reaction of water and isocyanate in the layers to form carbon dioxide that “pops” out of the coating surface. As the film thickness of each waterborne layer increases, the instance of popping tends to increase because the layer has a larger volume, creating the potential for more residual water and isocyanate to be present in the layer. In many existing waterborne coating systems, in order to achieve a popping density of less than about 3 pops per square centimeter, the film thickness of the waterborne layers has to be less than the above-recited film thicknesses. A coating system with thinner layers does not provide as much protection to the substrate as a coating system with thicker layers.

Without being bound by any theory, it is believed that the specific combination of the water-dilutable, hydroxyl-functional (meth)acrylate copolymer and the polyisocyanate compound in the waterborne clearcoat composition leads to rapid emulsification of the polyisocyanate compound, minimizing the amount of polyisocyanate remaining in the layers and thus inhibiting the reaction of any remaining isocyanate with water trapped in the layer to form carbon dioxide that might cause popping in the surface of the clearcoat layer.

In embodiments, a multilayer coating comprising a cured film of the waterborne clearcoat composition and an underlying cured film of a waterborne underlying composition exhibits wet adhesion performance, as evaluated by a cross-cut tape test using a test method based on the standard methods ASTM D2247-92 and ASTM D3359-92A, that is at least equivalent to the wet adhesion performance of a multilayer coating comprising a cured film of a solvent borne clearcoat composition and an underlying cured film of a solvent borne underlying composition. In embodiments, a multilayer coating comprising a cured film of the waterborne clearcoat composition and an underlying cured film of a waterborne underlying composition exhibits appearance characteristics, as evaluated using a BYK® wave-scan Orange Peel Meter, that are at least equivalent to the appearance characteristics of a multilayer coating comprising a cured film of a solvent borne clearcoat composition and an underlying cured film of a solvent borne underlying composition.

Methods of forming the composite articles are also provided herein. The method comprises the steps of applying a waterborne underlying composition comprising an acrylic latex resin to a substrate to form an underlying layer disposed over the substrate, applying a waterborne clearcoat composition to the underlying layer to form a clearcoat layer disposed over the underlying layer, and curing the underlying layer and the clearcoat layer. In embodiments, if the waterborne underlying composition is a multi-part composition, the parts of the waterborne underlying composition are combined and mixed before the waterborne underlying composition is applied to the substrate. In embodiments, the clearcoat binder part and the clearcoat crosslinker part of the two-part waterborne clearcoat composition are combined and mixed before the waterborne clearcoat composition is applied over the waterborne underlying layer. The steps of applying a waterborne underlying composition and applying a waterborne clearcoat composition may comprise any known application method. For example, the waterborne underlying composition may be applied by spraying, brushing, rolling, spackling, or dipping. The waterborne underlying composition and the waterborne clearcoat composition may be applied using the same method, or alternatively, the waterborne underlying composition and the waterborne clearcoat composition may be applied using different methods. Curing the resulting underlying layer and the clearcoat layer may comprise air drying, flash drying, baking, or any other known method of curing. Air drying may be done at a temperature of about 25° C. for a period of from about 15 minutes to about 24 hours, alternatively from about 1 hour to about 12 hours. Flash drying may be done for a period of from about 5 minutes to about 15 minutes. The films may be flash dried and then baked. Baking may be done at a temperature of from about 40° C. to about 80° C., alternatively from about 50° C. to about 70° C., for a period of from about 15 minutes to about 2 hours, alternatively from about 15 minutes to about 1 hour. The underlying layer and the clearcoat layer may be cured at the same time (i.e. wet on wet application), or alternatively, the underlying layer and the clearcoat layer may be cured sequentially. In embodiments, the underlying layer is cured before the waterborne clearcoat composition is applied.

### EXAMPLES

### Examples 1-3 and Comparative Example 1

Two water-dilutable, hydroxyl-functional (meth)acrylate copolymer resins were prepared. Resin 1 was prepared according to the synthesis examples in the patent application U.S. 63/624,392. Resin 2 was prepared according to the patent application EP1784463B. The properties of Resin 1 and Resin 2 are shown below in Table 1.

TABLE 1
Properties of Resin 1 and Resin 2

| | | | | | Molecular |
|---|---|---|---|---|---|
| | | OH Value | Acid Value | Solid Content | Weight |
| | Tg (° C.) | (mgKOH/g) | (mgKOH/g) | (wt %) | (Daltons) |
| Resin 1 | 37.6 | 135 | 27 | 44 | 17,000 |
| Resin 2 | 34.0 | 153 | 31 | 44.5 | 26,000 |

In Table 1, the Tg is the glass transition temperature in degrees Celsius, as calculated using the Fox equation. The OH value is the hydroxyl value, as analyzed in accordance with the standard test method ASTM D4274-11. The acid value is determined in accordance with ASTM D974-22. The solid content is a weight percentage based on a total weight of the resin. The molecular weight is the weight average molecular weight in Daltons, as measured with gel permeation chromatography (GPC) using polystyrene calibration standards in accordance with ASTM 3536.

Two-part (2 k) clearcoat compositions (Clearcoat 1 and Clearcoat 2) were then prepared. First, a Part A and a Part B were prepared according to Table 2 below.

TABLE 2
Composition of Clearcoat Compositions 1 and 2
Part A

| Component | Clearcoat 1 | Clearcoat 2 |
|---|---|---|
| Resin 1 | 0.0% | 56.0% |
| Resin 2 | 52.1% | 0.0% |
| Propylene Glycol | 3.6% | 3.0% |
| Methyl Ether | | |
| Mineral Spirits | 0.6% | 0.6% |
| Silicone Surfactant | 0.3% | 0.3% |
| Silicone-Containing | 0.1% | 0.1% |
| Surface Additive | | |
| Hindered Light | 0.3% | 0.3% |
| Stabilizer | | |
| UV Absorber | 0.5% | 0.5% |
| Deionized Water | 6.0% | 1.9% |
| Total | 63.5% | 62.8% |

Part B

| Component | Clearcoat 1 | Clearcoat 2 |
|---|---|---|
| Butyl Glycol Acetate | 8.8% | 8.8% |
| Hexamethylene Diisocyanate | 12.0% | 11.6% |
| trimer (HDI trimer) | | |
| Total | 20.8% | 20.4% |

The percentages in Table 2 represent the weight percent of the respective component, based on a total weight of both the Part A and Part B together with a deionized (DI) water reducer that was added to reach a total of 100%.

For each of Clearcoat 1 and Clearcoat 2, the Part B was added to Part A and mixed until uniform. Then, the DI water reducer was added to each mixture, and each mixture was mixed again to form the clearcoat compositions.

Then, electrocoated panels were obtained. For Examples 1 and 2, the waterborne clearcoat compositions Clearcoat 1 and Clearcoat 2 as described above, respectively, were spray applied onto the electrocoated panels to form a clearcoat layer having a film thickness of 67.5 μm. The clearcoat layer was flashed for 10 minutes, and then baked for 30 minutes in an oven preheated to a temperature of 60° C. with an air flow in the range of 35-55 meters per minute.

For Example 3, a waterborne sealer composition available from Spies Hecker® GmbH under the trade name Permahyd® 5650 was spray applied to the electrocoated panel to form a sealer layer having a film thickness of 20 μm. The sealer layer was air dried. Then, a commercial waterborne metallic blue basecoat composition was spray applied over the sealer layer to form a basecoat layer having a film thickness of 15 μm. The basecoat layer was flash dried at a temperature of 25° C. for 30 minutes. Then, the waterborne clearcoat composition Clearcoat 2 as described above was spray applied over the basecoat layer to form a clearcoat layer having a film thickness of 67.5 μm. The layers were flashed for 10 minutes, and then baked for 30 minutes in an oven preheated to a temperature of 60° C. with an air flow in the range of 35-55 meters per minute.

For Comparative Example 1, the procedure for Example 3 was followed, except that the clearcoat composition Clearcoat 1 was used to form the clearcoat layer.

The popping density of each of Examples 1-3 and Comparative Example 1 was measured by visually observing a surface area of 1 cm by 8 cm on the surface of the clearcoat layer with the naked eye at a distance of 30 cm under a fluorescent light source. The number of pops in the area was counted, and the number of pops was divided by the area of observation (popping density=number of pops/8 cm²). For each Example, three separate areas were observed to determine the popping density of each area, and the average popping density over the three areas was reported (average popping density=(popping density of area 1+popping density of area 2+popping density of area 3)/3). The results are shown in Table 3 below.

TABLE 3
Popping Density for Examples 1-4

| Coating System | Popping Density (pops/cm²) |
|---|---|
| Example 1 | 0 |
| Example 2 | 0 |
| Example 3 | 2.08 |
| Comparative Example 1 | 6.17 |

For Example 3 and Comparative Example 1, the appearance of the coating system was assessed by measuring the distinctness of image (DOI), shortwave (SW), longwave (LW), and du (dullness). Specifically, the DOI was measured using ASTM D5767-18 Standard Test Method for Instrumental Measurement of Distinctness-of-Image (DOI) Gloss of Coated Surfaces. The scale values obtained with the measuring procedures of this test method range from 0 to 100, with a value of 100 representing perfect DOI (image clarity). As the value decreases from 100, the image becomes more distorted. The wave scan, which is intended to simulate visual perception, was performed using a Wavescan-DOI apparatus available from BYK-Gardner GmbH. The instrument provided a laser point light source which illuminated the specimen at a 60° angle. An associated detector measured the reflected light intensity at the equal but opposite angle. The shortwave signal (structure size<0.6 mm) was divided from the measured signal using a mathematical filter function. The meter was rolled across the surface and measured, point-by-point, the optical profile of the surface across a defined distance. The short-term waviness value as provided in Table 4 represents the variance of the shortwave signal amplitude and has been normalized to a unitless value in the range of from 0 to 100, wherein 0 depicts the lowest variance (best) and 100 depicts the highest variance (worst). The dullness was measured using a Wavescan-DOI apparatus available from BYK-Gardner GmbH. A green light emitting diode (LED) illuminated the specimens at a 20° angle. The diffused light-caused by surface structures smaller than 0.1 mm in size—was measured with a charge-coupled device (CCD) camera. In operation, the CCD camera analyzes the reflected image of the light source's aperture: if there are no fine-micro textures in the coating specimen, all light will be detected within the image of the aperture (Lmax); otherwise, light will be detected outside (Lscatter). The ratio (Lscatter/Lmax) of these two components is defined as Dullness (structure size<0.1 mm). The dullness measurement is independent of the refractive index and the curvature of the surface as it is a relative rather than absolute measurement.

The results are shown below in Table 4.

TABLE 4
Characteristics of Coatings for Example
3 and Comparative Example 1

| Coating System | DOI | SW | LW | du |
|---|---|---|---|---|
| Example 3 | 89.6 | 15.2 | 5.4 | 12 |
| Comparative | 83.6 | 26.4 | 6.4 | 19 |
| Example 1 | | | | |

Examples 1-3 and Comparative Example 1 show that the waterborne clearcoats do not exhibit popping when there are no waterborne underlying layers. When waterborne underlying layers are added, the clearcoat composition having Resin 1 performs better than the clearcoat composition having Resin 2 in terms of popping density and appearance characteristics.

### Example 4

Electrocoated panels were obtained. For Example 4, a waterborne sanding surfacer (Surfacer 1) as described in patent application 63/709,854, containing aliphatic polyisocyanate, was spray applied on the coated panel to form a surfacer layer having a film thickness of 75 μm. The surfacer layer was air dried overnight in a room having a temperature of 25° C. Then, a metallic black waterborne basecoat was spray applied over the surfacer layer to form a basecoat layer having a film thickness of 15 μm. The basecoat layer was air dried. Then, the waterborne clearcoat composition Clearcoat 1, as described above, was spray applied over the basecoat layer to form a clearcoat layer having a film thickness of 52 μm. The layers were flashed for 10 minutes and then baked for 30 minutes in an oven set to a temperature of 60° C. and allowed to heat from room temperature to 60° C., with an air flow in the range of 10-25 meters per minute.

### Comparative Example 2

For Comparative Example 2, a commercial solvent borne sanding surfacer was spray applied on the coated panel to form a surfacer layer having a film thickness of 75 μm. The surfacer layer was air dried overnight in a room having a temperature of 25° C. Then, a metallic black waterborne basecoat was spray applied over the surfacer layer to form a basecoat layer having a film thickness of 15 μm. The basecoat layer was air dried. Then, the waterborne clearcoat composition Clearcoat 1, as described above, was spray applied over the basecoat layer to form a clearcoat layer having a film thickness of 52 μm. The layers were flashed for 10 minutes and then baked for 30 minutes in an oven preheated to a temperature of 60° C. with an air flow in the range of 35-55 meters per minute.

For each of Example 4 and Comparative Example 2, the popping density was evaluated as described above for Examples 1-3. The results are shown in Table 7 below.

TABLE 7
Popping Density Results

| | Pop Density (pops/cm²) |
|---|---|
| Example 4 | 0.07 |
| Comparative Example 2 | 0.11 |

The results in Table 7 show that a coating system using waterborne Surfacer 1 performs equivalently to a coating system using a solvent borne surfacer, when used in combination with a waterborne basecoat and waterborne clearcoat.

### Examples 5-8

A two-part (2 k) clearcoat composition (Clearcoat 3) was prepared. First, a Part A and a Part B were prepared according to Table 5 below.

TABLE 5
Composition of Clearcoat Composition 3
Part A

| Component | Clearcoat 3 |
|---|---|
| Resin 1 | 47.2% |
| Polyester 1 | 2.4% |
| Propylene Glycol Methyl Ether | 0.3% |
| Mineral Spirits | 0.9% |
| N,N-dimethylethanolamine | 0.1% |
| Deionized Water | 4.1% |
| Silicone Surfactant | 0.3% |
| Silicone-Containing Surface Additive | 0.1% |
| Hindered Light Stabilizer | 0.4% |
| UV Absorber | 0.5% |
| Total | 56.3% |

Part B

| Component | Clearcoat 3 |
|---|---|
| Butyl Glycol Acetate | 7.1% |
| Bayhydur ® SP2655 | 2.5% |
| Hexamethylene Diisocyanate trimer | 13.7% |
| (HDI trimer) | |
| Total | 23.3% |

The percentages in Table 5 represent the weight percent of the respective component, based on a total weight of both Part A and Part B together with a deionized (DI) water reducer that was added to reach a total of 100%.

Polyester 1 is a non-aromatic polyester having active hydrogen groups, prepared according to the synthesis example in the patent application U.S. 63/624,388.

For Clearcoat 3, Part B was added to Part A and mixed until uniform. Then, the DI water reducer was added to each mixture, and each mixture was mixed again to form the clearcoat compositions.

A core-shell latex copolymer having pendant hydroxyl groups and pendant carbonyl groups (Resin 3) was prepared according to patent application 63/709,857. The monomers used to form the core-shell latex copolymer comprise 3.7 wt % of carbonyl functional ethylenically unsaturated monomer based on total weight of monomer mixture. The characteristics of Resin 3 were measured as described above for Resin 1 and Resin 2. The core copolymer of Resin 3 had a calculated Tg of 69.5° C., and the shell copolymer of Resin 3 had a calculated Tg of 0.7° C. Resin 3 had an acid value of 0.9 mgKOH/g, a hydroxyl value of 12.2 mgKOH/g, and a solids content of 46.3%.

A millbase (Millbase 1) was formed by grinding together the components shown in Table 8 in the amounts shown in Table 8 below.

TABLE 8
Components of Millbase 1

| Component | Amount (wt %) |
|---|---|
| Barium Sulfate | 19.2% |
| Talcum | 13.2% |
| Aluminum Silicate | 18.1% |
| Titanium Dioxide | 17.1% |
| Dispersant 1 | 4.0% |
| Dispersant 2 | 8.1% |
| Heavy Naphtha | 1.4% |
| Pentanol | 1.0% |
| Aminomethyl Propanol | 0.1% |
| Anti-Rust Additive | 0.5% |
| Non-ionic Surfactant | 1.7% |
| Deionized Water | 15.6% |

The percentages in Table 8 represent the weight percent of the respective component, based on a total weight of the millbase.

Dispersant 1 is a solution of an acrylic resin having an acid value of 106 mgKOH/g.

Dispersant 2 is a solution of an acrylic resin having hydroxyl functionality and having an acid value of 44 mgKOH/g.

The anti-rust additive is a liquid rust inhibitor commercially available from ICL Performance Products LP under the trade name Halox® Flash X-150.

The non-ionic surfactant is a 75 wt % solution of Surfonyl® 104H, commercially available from Evonik Industries, in ethyl glycol monobutyl ether.

A black dispersion (Black Dispersion 1) was formed using the components shown in Table 9 in the amounts shown in Table 9 below.

TABLE 9
Components of Black Dispersion 1

| Component | Amount (wt %) |
|---|---|
| Deionized Water | 68.0% |
| Dispersant 3 | 12.8% |
| Non-Ionic Surfactant | 1.0% |
| Aminomethyl Propanol | 2.2% |
| Carbon Black | 16.0% |

The percentages in Table 9 represent the weight percent of the respective component, based on a total weight of the black dispersion.

Dispersant 3 is a polymeric dispersant commercially available from The Lubrizol Corporation under the trade name Solsperse® 27000.

The non-ionic surfactant is a 75 wt % solution of Surfonyl® 104H, commercially available from Evonik Industries, in ethyl glycol monobutyl ether.

To form the black dispersion, all the components in Table 9 except for the carbon black were added to a contained and mixed for 15 minutes using an air mixer. Then, the carbon black was added to the container without stopping the air mixer. Mixing was continued for another 30 minutes. The resulting dispersion was ground with an LMZ mill and then filtered through a 10 μm filter to form Black Dispersion 1.

Two waterborne sanding surfacer compositions were prepared having the components shown in Table 10 in the amounts shown in Table 10 below.

TABLE 10
Compositions of Surfacer 2 and Surfacer 3
Part A

| Component | Surfacer 2 | Surfacer 3 |
|---|---|---|
| Millbase 1 | 56.4% | 58.6% |
| Black Dispersion 1 | 0.3% | 0.3% |
| Resin 3 | 36.6% | 25.5% |
| Adipic Acid Dihydrazide | 0.2% | 0.2% |
| Resin 2 | 0% | 8.9% |
| Total | 93.5% | 93.5% |

Part B

| Component | Surfacer 2 | Surfacer 3 |
|---|---|---|
| Aliphatic polyisocyanate | 2.6% | 2.6% |
| Ethyl 3-ethoxypropionate | 2.0% | 2.0% |
| Epoxysilane | 2.0% | 2.0% |
| Total | 6.5% | 6.5% |

The percentages in Table 10 represent the weight percent of the respective component, based on a total weight of both Part A and Part B.

To form Surfacer 2 and Surfacer 3 using the components shown above in Table 10, the Resin 3 and the adipic acid dihydrazide (ADH) were mixed in a high speed mixer-disperser operated at 1000 rpm for 10 minutes. Then, the Millbase 1 and the Black Dispersion 1 were added and mixed for another 30 minutes. Then, the components of Part B in Table 10 were added to form the final composition.

For Example 5, the sanding surfacer composition Surfacer 2 was spray applied onto an electrocoated panel to form a surfacer layer having a film thickness of 50 μm. The surfacer layer was air dried for 3 hours in a room having a temperature of 25° C. Then, the surfacer layer was sanded. A commercial metallic blue waterborne basecoat composition was spray applied over the surfacer layer to form a basecoat layer having a film thickness of 15 μm. The basecoat layer was air dried. The clearcoat composition Clearcoat 3 was spray applied over the basecoat layer to form a clearcoat layer having a film thickness of 55 μm. The clearcoat layer was flashed for 10 minutes, and then baked for 30 minutes in an oven set to a temperature of 60° C. and allowed to heat from room temperature to 60° C., with an air flow in the range of 10-25 meters per minute.

For Example 6, the procedure of Example 5 was followed, except that the film thickness of the surfacer layer was 100 μm.

For Example 7, the procedure of Example 5 was followed, except that the sanding surfacer composition Surfacer 3 was used to form the surfacer layer.

For Example 8, the procedure of Example 7 was followed, except that the film thickness of the surfacer layer was 100 μm.

### Comparative Examples 3-6

For Comparative Example 3, a commercial solvent borne sanding surfacer composition was spray applied onto an electrocoated panel to form a surfacer layer having a film thickness of 50 μm. The surfacer layer was air dried for 3 hours in a room having a temperature of 25° C. Then, the surfacer layer was sanded. A commercial metallic blue waterborne basecoat composition was spray applied over the surfacer layer to form a basecoat layer having a film thickness of 15 μm. The basecoat layer was air dried. The clearcoat composition Clearcoat 3 was spray applied over the basecoat layer to form a clearcoat layer having a film thickness of 55 μm. The clearcoat layer was flashed for 10 minutes, and then then baked for 30 minutes in an oven set to a temperature of 60° C. and allowed to heat from room temperature to 60° C., with an air flow in the range of 10-25 meters per minute.

For Comparative Example 4, the procedure of Comparative Example 3 was followed, except that the surfacer layer had a film thickness of 100 μm.

For Comparative Example 5, the procedure of Comparative Example 3 was followed, except that a commercial solvent borne clearcoat composition was used to form the clearcoat layer.

For Comparative Example 6, the procedure of Comparative Example 5 was followed, except that the surfacer layer had a film thickness of 100 μm.

For Examples 5-8 and Comparative Examples 3-6, the popping performance was rated as a “pass” or “fail,” where a pass means that the popping density is less than 0.1 pops per square centimeter, and a fail means that the popping density is more than 0.1 pops per square centimeter. The appearance characteristics were assessed by measuring the DOI as described above for Examples 1-3. The results are shown in Table 11 below.

TABLE 11
Popping Performance and Appearance Characteristics

| | Popping | |
|---|---|---|
| | Performance | DOI |
| Example 5 | pass | 84.8 |
| Example 6 | pass | 84.8 |
| Example 7 | pass | 89.0 |
| Example 8 | pass | 89.0 |
| Comparative | pass | 87.8 |
| Example 3 | | |
| Comparative | pass | 87.8 |
| Example 4 | | |
| Comparative | pass | 89.4 |
| Example 5 | | |
| Comparative | pass | 89.4 |
| Example 6 | | |

The results in Table 11 show that a full waterborne coating system using Clearcoat 2 in combination with Surfacer 2 or Surfacer 3 performs similarly to a system where the clearcoat and/or the surfacer is replaced with a solvent borne composition.

### Comparative Examples 7-8

A millbase (Millbase 2) was prepared by grinding together the components shown in Table 12 in the amounts shown in Table 12 below.

TABLE 12
Components of Millbase 2

| Component | Amount (wt %) |
|---|---|
| Barium Sulfate | 9.7% |
| Talcum | 11.2% |
| Aluminum Silicate | 13.0% |
| Titanium Dioxide | 24.8% |
| Dispersant 2 | 5.3% |
| Non-ionic Surfactant | 1.3% |
| Carbon Black | 0.1% |
| Resin 2 | 15.0% |
| Deionized Water | 19.5% |

A sanding surfacer composition (Surfacer 4) was formed using the components shown in Table 13 in the amounts shown in Table 13 below.

TABLE 13
Components of Surfacer 4
Part A

| Component | Amount (wt %) |
|---|---|
| Millbase 2 | 66.2% |
| Resin 2 | 4.1% |
| Resin 3 | 20.6% |
| Total | 90.9% |

Part B

| Component | Amount (wt %) |
|---|---|
| Aliphatic polyisocyanate | 7.3% |
| Ethyl 3-ethoxypropionate | 1.8% |
| Total | 9.1% |

The percentages in Table 13 represent the weight percent of the respective component, based on a total weight of both Part A and Part B.

To form the composition for Surfacer 4, the components of Part A shown in Table 13 were combined and mixed in a high speed mixer-disperser operated at 1000 rpm for 30 minutes. The components of Part B shown in Table 13 were separately blended.

For Comparative Example 7, the sanding surfacer composition Surfacer 4 was spray applied to an electrocoated panel to form a surfacer layer. The film thickness of the surfacer layer varied in a gradient across the panel from 50 μm to 150 μm. The surfacer layer was flashed for 10 minutes and then baked for 30 minutes in an oven set to a temperature of 60° C. and allowed to heat from room temperature to 60° C., with an air flow in the range of 10-25 meters per minute.

For Comparative Example 8, the procedure for Comparative Example 7 was followed except that a commercial two-part waterborne sanding surfacer based on isocyanate reacting with an acrylate dispersion was used to form the surfacer layer.

After baking, the instance of popping was visually observed on the surface of the surfacer layer on each coated panel. The amount of pops per square centimeter increased with increasing film thickness for both Comparative Example 7 and Comparative Example 8. The film thickness at which pops became visible (the “critical film build”) was recorded for each coated panel. For Comparative Example 7, the critical film build was 120 μm. For Comparative Example 8, the critical film build was 70 μm.

Comparative Examples 7-8 show that Surfacer 4 exhibits better popping performance than a commercially available waterborne surfacer.

### Example 9 and Comparative Example 9

For Example 9, the sanding surfacer composition Surfacer 4 was spray applied onto an electrocoated panel to form a surfacer layer having a film thickness of 70 μm. The surfacer layer was then baked for 30 minutes in an oven set to a temperature of 60° C. and allowed to heat from room temperature to 60° C., with an air flow in the range of 10-25 meters per minute. A black waterborne basecoat composition was spray applied over the surfacer layer to form a basecoat layer having a film thickness of 13 μm. The basecoat layer was air dried. Then, the clearcoat composition Clearcoat 3 was spray applied over the basecoat layer to form a clearcoat layer having a film thickness of 48 μm. The layers were flashed for 10 minutes and then baked for 30 minutes in an oven set to a temperature of 60° C. and allowed to heat from room temperature to 60° C., with an air flow in the range of 10-25 meters per minute.

For Comparative Example 9, the procedure of Example 9 was followed, except that the commercial waterborne surfacer composition described above for Comparative Example 8 was used to form the surfacer layer, the surfacer layer had a film thickness of 59 μm, and the clearcoat layer had a film thickness of 46 μm.

For Example 9 and Comparative Example 9, the popping performance was rated as “pass” or “fail” as described above for Examples 5-8. The appearance characteristics were assessed by measuring the DOI, LW, SW, and du as described above for Examples 1-3. The gloss was also measured at a 20 degree angle by a micro TRI gloss device from Byk Gardner (Germany). The reflected light is measured at an angle of 20°. The results are shown in Table 14 below.

TABLE 14
Popping Performance and Appearance Characteristics

| | Popping | | | | | Gloss |
|---|---|---|---|---|---|---|
| | Performance | DOI | LW | SW | du | (GU) |
| Example 9 | pass | 93.9 | 2.6 | 15.6 | 2.6 | 88.4 |
| Comparative | pass | 92.9 | 3.1 | 16.8 | 3.1 | 88.1 |
| Example 9 | | | | | | |

Clearcoat 3 exhibits acceptable popping density and appearance characteristics when combined with different waterborne surfacers. The results also show that a layer formed from Surfacer 4 can have a greater film thickness than a layer formed from a commercial waterborne surfacer and still show equivalent popping performance.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment of the present disclosure. It being understood that various changes may be made in the function and arrangement of elements described in an exemplary embodiment without departing from the scope of the present disclosure as set forth in the appended claims.

What is claimed is:

1. A coating system comprising:
a waterborne underlying composition comprising an acrylic latex resin; and
a two-part waterborne clearcoat composition comprising:
a clearcoat binder part comprising a water-dilutable, hydroxyl-functional (meth)acrylate copolymer; and
a clearcoat crosslinker part comprising a polyisocyanate compound having pendant —NCO groups;
wherein the molar ratio of active hydrogen atoms to-NCO groups in the waterborne clearcoat composition is from about 1:5 to about 5:1;
wherein a cured film of the waterborne clearcoat composition having a film thickness of 67.5 μm overlying a cured film of the waterborne underlying composition having a film thickness of 20 μm disposed on a substrate exhibits a popping density of less than about 3 pops per square centimeter, as measured by visual observation with the naked eye at a distance of 30 cm under a fluorescent light source.

2. The coating system of claim 1, wherein the waterborne underlying composition is a waterborne sealer composition.

3. The coating system of claim 1, wherein the water-dilutable, hydroxyl functional (meth)acrylate copolymer of the waterborne clear coat composition has a glass transition temperature of from about 20° C. to about 50° C., as calculated using the Fox equation.

4. The coating system of claim 1, wherein the water-dilutable, hydroxyl functional (meth)acrylate copolymer of the waterborne clear coat composition has a hydroxyl value of from about 110 mgKOH/g to about 160 mgKOH/g, as analyzed in accordance with the standard test method ASTM D4274-11.

5. The coating system of claim 1, wherein the water-dilutable, hydroxyl functional (meth)acrylate copolymer of the waterborne clear coat composition has an acid value of from about 20 mgKOH/g to about 40 mgKOH/g.

6. The coating system of claim 1, wherein the water-dilutable, hydroxyl functional (meth)acrylate copolymer of the waterborne clear coat composition has a weight average molecular weight of from about 10,000 Daltons to about 30,000 Daltons, as measured by gel permeation chromatography using polystyrene calibration standards in accordance with ASTM 3536.

7. The coating system of claim 1, wherein the water-dilutable, hydroxyl functional (meth)acrylate copolymer in the waterborne clearcoat composition is the reaction product of monomers in a monomer mixture comprising, based on a total weight of monomers:
from about 20 to about 60 wt % of (i) a hydroxyl functional adduct of a monoepoxyester and an unsaturated carboxylic acid;
from about 10 to about 30 wt % of (ii) a hydroxyl functional unsaturated monomer different from compound (i);
from about 2 to about 6 wt % of (iii) an unsaturated acid functional monomer;
from about 20 to about 60 wt. % of (iv) a (meth)acrylate monomer represented by Formula MA: 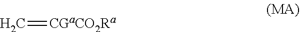
wherein: G^{a} is hydrogen, halogen or methyl; and
R^{a} is: C₁-C₁₈ alkyl; C₂-C₁₈ heteroalkyl; C₃-C₁₈ cycloalkyl; C₂-C₈ heterocycloalkyl; C₂-C₈ alkenyl; or, C₂-C₈ alkynyl;
from about 0 to about 15 wt. % of (v) at least one vinyl aromatic monomer; and
from about 0 to about 20 wt. % of (vi) at least one polymerizable unsaturated monomer that is different from (i) to (v).

8. The coating system of claim 1, wherein the waterborne underlying composition is a waterborne surfacer composition comprising:
a surfacer binder part comprising a core-shell latex comprising a core copolymer and a shell copolymer, wherein the core copolymer and the shell copolymer have pendant carbonyl groups.

9. The coating system of claim 8, wherein a cured film of the waterborne clearcoat composition having a film thickness of 67.5 μm overlying a cured film of the waterborne underlying composition having a film thickness of 120 μm disposed on a substrate exhibits a popping density of less than about 3 pops per square centimeter, as measured by visual observation with the naked eye at a distance of 30 cm under a fluorescent light source.

10. The coating composition of claim 8, wherein the surfacer binder part further comprises a water-dilutable, hydroxyl-functional (meth)acrylate copolymer.

11. The coating composition of claim 8, wherein the surfacer binder part further comprises a polyhydrazide compound.

12. The coating composition of claim 8, wherein the molar ratio of hydrazide groups to carbonyl groups in the waterborne surfacer composition is from about 1:5 to about 5:1.

13. The coating system of claim 11, wherein the polyhydrazide compound has at least two hydrazide groups of the formula —C(═O)—NH—N(R^{h})(Rⁱ), wherein R^{h} and Rⁱ are independently H or C₁-C₁₂ alkyl.

14. The coating system of claim 8, wherein the waterborne surfacer composition is a two-part composition further comprising:
a surfacer crosslinker part comprising a polyisocyanate compound.

15. The coating system of claim 8, wherein each of the core copolymer and the shell copolymer in the waterborne surfacer composition is formed from:
a (meth)acrylate monomer represented by Formula MA: 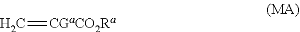
wherein: G^{a} is hydrogen, halogen or methyl; and
R^{a} is: C₁-C₁₈ alkyl; C₂-C₁₈ heteroalkyl; C₃-C₁₈ cycloalkyl; C₂-C₈ heterocycloalkyl;
C₂-C₈ alkenyl; C₂-C₈ alkynyl; C₆-C₁₈ aryl, C₁-C₉ heteroaryl, C₇-C₁₈ alkoxyaryl, C₇-C₁₈ alkaryl or C₇-C₁₈ aralkyl.

16. The coating system of claim 8, wherein each of the core copolymer and the shell copolymer in the waterborne surfacer composition is formed from:
a vinyl aromatic monomer;
a monomer having at least two (meth)acrylate groups;
a monomer having an allyl group and a (meth)acrylate group; and/or
a hydroxyl functional ethylenically unsaturated monomer.

17. The coating system of claim 8, wherein the core copolymer and/or the shell copolymer in the waterborne surfacer composition is formed from a carbonyl functional ethylenically unsaturated monomer.

18. A composite article, comprising:
a substrate;
an underlying layer disposed over the substrate, wherein the underlying layer is formed from a waterborne underlying composition comprising an acrylic latex resin; and
a clearcoat layer disposed over the underlying layer, wherein the clearcoat layer is formed from a two-part waterborne clearcoat composition comprising:
a clearcoat binder part comprising a water-dilutable, hydroxyl-functional (meth)acrylate copolymer; and
a clearcoat crosslinker part comprising a polyisocyanate compound having pendant —NCO groups;
wherein the molar ratio of active hydrogen atoms to-NCO groups in the waterborne clearcoat composition is from about 1:5 to about 5:1;
wherein the clearcoat layer exhibits a pop density of less than about 3 pops per square centimeter, as measured by visual observation with the naked eye at a distance of 30 cm under a fluorescent light source, when the underlying layer has a film thickness of 20 μm and the clearcoat layer has a film thickness of 67.5 μm.

19. The composite article of claim 18, free of any layers formed from a solvent borne coating composition.

20. A method of forming a composite article, the method comprising the steps of:
applying a waterborne underlying composition comprising an acrylic latex resin to a substrate to form an underlying layer disposed over the substrate;
applying a waterborne clearcoat composition to the underlying layer to form a clearcoat layer disposed over the underlying layer;
wherein the waterborne clearcoat composition comprises:
a clearcoat binder part comprising a water-dilutable, hydroxyl-functional (meth)acrylate copolymer; and
a clearcoat crosslinker part comprising a polyisocyanate compound having pendant —NCO groups;
wherein the molar ratio of active hydrogen atoms to-NCO groups in the waterborne clearcoat composition is from about 1:5 to about 5:1; and
curing the underlying layer and the clearcoat layer;
wherein the clearcoat binder part and the clearcoat crosslinker part are mixed before the waterborne clearcoat composition is applied to the underlying layer;
wherein the clearcoat layer exhibits a pop density of less than about 3 pops per square centimeter, as measured by visual observation with the naked eye at a distance of 30 cm under a fluorescent light source, when the underlying layer has a film thickness of 20 μm and the clearcoat layer has a film thickness of 67.5 μm.
